(19) United States
(12) Patent Application Publication
(10) Pub. No.: US 2010/0158648 A1
(43) Pub. Date: Jun. 24, 2010

(54) Vertical elevator and method for operating a rack by means of the vertical elevator

(76) Inventor: Gerhard Schäfer, Neunkirchen (DE)

Correspondence Address: KEVIN J. MCNEELY, ESQ., 5335 WISCONSON AVENUE, NW, SUITE 440, WASHINGTON, DC, 20015, US

(21) Appl. No.: 12/596,735

(22) PCT Filed: Apr. 11, 2008
(86) PCT No.: PCT/EP08/02882

§ 371 Date: Jan. 24, 2010

(30) Foreign Application Priority Data
Apr. 12, 2007 (DE) 10 2007 018 244.0

(51) Int. Cl. B65G 1/127; B65G 1/04; B65G 17/12

(52) U.S. Cl. 414/286; 414/807

(57) ABSTRACT

An order-picking system comprising a storage rack, wherein the rack (16, 18) is divided into a number of planes (RPi) arranged on top of each other each having rack-storage locations (54) arranged side-by-side, which are preferably formed by hold elements mounted laterally to rack posts, and wherein the rack is coupled to a vertical elevator, wherein the vertical elevator (12, 14) serves for transporting load supports (50) from a rack-plane level (RRi) of the storage rack (16, 18) to a handing-over level, and vice versa, wherein the elevator (12, 14) is provided with a first vertical traction unit (40) endlessly rotating, and a second vertical traction unit (42) endlessly rotating, wherein the first and second traction unit (40, 42) can be driven substantially synchronous and are distanced to each other such that a plurality of first support elements (48), which are mounted on the first traction unit (42), and a plurality of second support elements (48), which are mounted on the second traction unit (42), define a corresponding plurality of elevator-storage locations (55), on which load supports (50) can be conveyed in a vertical direction (26, 28) between the levels.

### RELATED APPLICATIONS

This is a continuation application of the co-pending International Application PCT/EP2008/002882 (WO 2008/125294 A1) filed on 11 Apr. 2008, which claims priority of the German patent application DE 10 2007 18 244 filed on 12 Apr. 2007, which is fully incorporated herewith by reference.

### BACKGROUND OF THE INVENTION

The present invention relates to a vertical elevator for transporting load supports from a rack plane to a handing-over level, and particularly to a storage rack having a corresponding elevator as well as to an order-picking system comprising such a storage rack. The invention additionally also relates to a method for storing and retrieving load supports by the vertical elevators arranged at or in the racks.

### RELATED PRIOR ART

A plurality of different articles is stored in a warehouse, particularly in an order-picking warehouse, namely on or in load supports, such as trays, containers, pallets or similar. For this purpose, the warehouse typically comprises a plurality of (storage) racks, which are arranged as single racks or double racks in terms of rack rows. Conventionally, two racks are standing oppositely along their longitudinal sides, and define rack aisle therebetween, in which a storage machine, such as a storage and retrieval device or a so-called shuttle, is movable. Typically, a rack consists of a number of rack planes being arranged on top of each other. Each rack plane comprises a number of rack locations (e.g. compartments) being arranged side-by-side. Since the racks occasionally can be relatively high, transportation of load supports, which have been retrieved from the rack beforehand by means of the storage machine, occurs in a vertical direction by means of an elevator. For this purpose, the storage machine typically hands over the load support to the elevator via storage elements, which are arranged between the elevator and the storage machine. The elevator comprises one or more load suspension devices, and transports a load support, which has been retrieved, in a vertical direction to a handing-over level for handing over the load support to a conveyor, such as a belt, roller track or similar. Such a warehouse is shown in DE 202 11 321 U1.

The capacity and performance of such conventional vertical elevators, which are typically arranged at front ends of the racks, is low. Due to the low capacity and the occasionally long ways, which have to be travelled in a vertical direction (e.g. from the highest rack plane to the ground), sufficient load supports can often not be transported in the vertical direction per unit of time. Thus, the vertical elevator is a key component, or a “bottleneck”, of the system. Additionally, for example, it is possible that the vertical elevator is not fast enough for receiving load supports, which are offered by the storage machines, particularly if a plurality of storage machines is used.

Another problem with conventional vertical elevators occurs, if the vertical elevator is used simultaneously for retrieving load supports from the rack and for storing (supply) load supports into the rack.

It is clear that the above explanations concern an order-picking system, which is operated in accordance with the “goods-to-man” principle. In this connection, for example, containers are retrieved from the rack and transported towards an order-picking person so that the order-picking person can subsequently remove a desired number of article units, and place them in an order container. Then, the container is typically stored back into the warehouse again.

The transportation of the load supports and the coordination thereof poses a fundamental problem in fully automated order-picking warehouses. Therefore, in the prior art different concepts had been suggested with respect to: how to structure a warehouse on principle, which storage machines are used; and according to which storing and retrieving strategy one works.

Beside the classic rack warehouses having static storage locations (compartments), so-called vertical rotary racks are known, which are also designated vertical carousels.

In a conventional rotary rack, storage locations for storing and retrieving are moved in a circulating manner towards a stationary access location. As long as there is any access, the system sleeps. With a so-called paternoster warehouse, having vertically rotating conveyor branches, “gondolas” or “storage troughs” are provided (in terms of single storage locations). The storage locations can be accessed laterally.

Further, carousel warehouses having horizontally rotating conveyor chains are known, on which movable storage frames are hanging. As a rule, the access occurs at the front end of this rack. Fields of applications for paternoster or carousel warehouses are, for example, small-parts warehouses, spare-parts warehouses, tool warehouses, document warehouses and card indexes. A historic field of application for a rotary warehouse is a vehicle parking paternoster.

Recently, there have been approaches to not arrange the (conventional) vertical elevators any longer at the front end, but along the longitudinal sides of the racks. In this manner a greater number of vertical elevators can be provided for one and the same rack. Thus, more load supports can be transported in the vertical direction. Such a warehouse is disclosed in the German patent application DE 10 2006 025 620, which was filed on May 24, 2006 on behalf of the applicant of the present application, the content of which is incorporated herewith by reference.

However, the lateral arrangement of the vertical elevators is disadvantageous in that a correspondingly constructed warehouse is relatively wide, since the laterally arranged vertical elevators need corresponding space.

The German patent application DE 101 14 271 A1 discloses a value-depot device having a value-cassette magazine arranged in a value-protection room, and comprising an access account being arranged in a separation wall. The value-depot device comprises a conveyor connecting the value-cassette magazine with the access account for transporting good cassettes between a respectively selected magazine compartment to the exit account. A control device of the conveyor device is in communication with an identification device. The value-protection room, comprising the value-cassette magazine and having the separation wall comprised by the access account, is arranged within a transportable depot housing. At least part of the depot housing enclosing the value-protection room is adapted to avoid burglaries. An access room within the depot housing follows, at the back side of the value-protection room, to the separation wall comprising the access account.

Thus, there is a need for an enhancement of the above-mentioned types of warehouse, wherein particularly a total width of the warehouse is to be reduced.

### SUMMARY OF THE INVENTION

Therefore, it is an object of the present invention to provide an order-picking system comprising racks and offering a sufficient transportation performance in a vertical direction.

This object is solved by an order-picking system comprising a storage rack, wherein the rack is divided into a number of rack planes arranged on top of each other and comprising rack-storage locations being arranged side-by-side, each of which is preferably defined by hold elements mounted laterally to rack posts, wherein a vertical elevator couples to the rack, wherein the vertical elevator serves for transportation of load supports from a rack-plane level of the storage rack to a handing-over level, and vice versa, wherein the elevator comprises a first vertical traction unit which rotates endlessly, and a second vertical traction unit, which rotates endlessly, wherein the first and second traction units can be driven substantially synchronously, and are distanced to each other so that a plurality of first support elements, which are mounted to the first traction device, and a plurality of second support elements, which are mounted to the second traction unit, define a corresponding plurality of elevator-storage locations on which load supports can be conveyed in the vertical direction between the levels.

The invention implements the paternoster principle. Two traction units, being arranged parallel and extending in the vertical direction, define a plurality of storage locations therebetween. For this purpose, the traction units comprise support elements having, for example, L-shaped cross sections on which load supports can be deposited freely. The support elements preferably reach beneath the load supports only in an outer-edge region of bottoms of the load supports. Platforms, on which the load supports can be deposited, or elevator-specific load-suspension devices are not required. Consequently, the elevator in accordance with the invention is small. The elevator comprises a plurality of elevator-storage locations. Load and load-support flow happens in the vertical direction “continuously” (preferably in a clocked manner).

In accordance with a preferred embodiment the elevator is connected to a front end of the storage rack.

This is advantageous in that the elevators do not need to be arranged laterally with respect to the rack. The distances between two neighboring racks get smaller, and sometimes can be omitted completely. Double racks can be realized. Nevertheless, high transportation performances can be obtained in the vertical direction.

Front-end connection of the elevator is further advantageous in that the storage machines of the rack are directly coupled to the vertical elevator of the present invention without additional handing-over elements or buffer locations. Thus, an exchange of the load supports occurs directly between the elevator and the storage machines. This is also true for the following arrangement.

In accordance with a preferred embodiment the elevator is integrated into the storage rack itself.

In this manner a number of elevators can be provided for each rack. In contrast to the front-end arrangement, for example, two additional vertical elevators can be provided separately from each other so that the performance in the vertical direction triples in total. All this happens without widening the rack laterally. The rack is merely extended longitudinally. It has been found advantageous if the first and second traction units are driven synchronously by means of, particularly one, drive unit.

Elevator-storage locations are defined by a space between two support elements, assigned to each other, of the first and second traction units. In order to prevent a load support from crashing, a relative position of the support elements is substantially not changing. Therefore, the traction units are driven synchronously. If the drive is caused by one single driving unit, then synchronization is already present immanently. Also, it is advantageous if the first and second traction units are respectively formed by two closed strands, which are endlessly rotating, such as chains. If each traction unit comprises two separate strands, the support elements can be fixed to the respective traction unit by a two-point suspension, resulting in a higher stability. Tilting, and thus a slipping-off of the load support, is excluded.

In this connection, it is advantageous if the two strands are connected to each other in a horizontal direction by means of the support elements.

In accordance with another preferred embodiment the support elements are formed identically with respect to the hold elements such as profile rails.

This measure ensures that the load-suspension device of the storage machine does not need to be adapted to the elevator-storage locations. The elevator-storage locations are modeled on the rack-storage locations with respect to their structure. For the storage machine, it does not make a difference to which storage location a load support is delivered, or from which storage location a load support is retrieved. For the storage machine merely the destination point varies, since a vertical elevator is somehow constructed broader in comparison to a storage location.

In accordance with another embodiment the load supports are moved back and forth, wherein the storage machines particularly can be driven vertically and horizontally.

In accordance with an advantageous embodiment a distance of the elevator-storage locations in a vertical direction, with respect to each other, is selected equal to a distance of the rack-storage locations.

The division of the elevator-storage locations thus corresponds to the division of the rack-storage locations. This in turn simplifies the control of the storage machines, since it does not make a difference for the storage machines to which type of storage location it has to travel. The destination points to be travelled to are equal in the vertical direction.

Furthermore, it has been found advantageous if the elevator-storage locations are single deep or multiple deep, preferably corresponding to a storage depth of the storage rack. Multiple deep means that a number of goods are storable one behind the other within one storage location.

In this manner it is possible that the storage machines can exchange load supports between the elevator and the rack without having to perform an interim buffering in order to allow handling of various storage depths.

Further, it is preferred if the support elements are formed and arranged so that they support a load support laterally at the bottom, and that a load-suspension device of a storage machine can freely reach beneath the bottom, in order to lift the load support into any elevator-storage location, or lift same out of any elevator-storage location.

Additionally, it is advantageous if the traction units further comprise return devices, the axes of which are orientated transversely to a longitudinal direction of the rack.

Particularly, load supports can be exchanged between the storage rack and the vertical elevator by means of a storage machine which is substantially displaceable in a longitudinal direction of the storage rack.

Preferably, a conveyor is connected to the vertical elevator, mainly at the handing-over level.

In accordance with another aspect of the present invention a method for storing and retrieving load supports in an order-picking system of the type as mentioned at the outset is provided, the method comprising the following steps: retrieving a load support from a predetermined rack-storage location, or from an elevator-storage location, transversely relative to a longitudinal direction of the rack by means of a load-suspension device of a storage machine; moving the storage machine in the longitudinal direction and/or in a vertical direction, in order to transport one or more load supports between the storage locations; delivering the retrieved load supports in a transverse direction to a predetermined elevator-storage location, or a rack-storage location; and synchronously moving, preferably in a clocked manner, the first and second traction units while the storage machine transports one or more load supports between the storage locations.

Further, it is preferred if the method comprises the additional steps of: moving the storage machine to a handing-over point opposite the elevator; and subsequently exchanging load support between the elevator and the storage machine in a transverse direction.

In accordance with another preferred embodiment the method comprises the further steps of: moving a load support stored in the elevator in a vertical direction up to the handing-over level; and delivering the load support in the transverse direction to a following conveyor.

It is clear, that the above-mentioned and hereinafter still to be explained features can not only be employed in the respectively given combination, but also in other combinations or alone, without departing from the scope of the present invention.

### BRIEF DESCRIPTION OF THE DRAWINGS

Embodiments of the invention are depicted in the drawings and will be explained in more detail in the following description, wherein:

FIG. 1 shows a perspective view of a rack having vertical elevators in accordance with the invention, being connected to the rack;

FIG. 2 shows a side view of the rack of FIG. 1;

FIG. 3 shows an enlarged section of FIG. 2;

FIG. 4 shows a front view of the system of FIG. 1;

FIG. 5 shows a top view on the system of FIG. 1;

FIG. 6 shows a vertical elevator in accordance with the present invention integrated into the rack; and

FIG. 7 shows a flow chart of a method of the present invention.

### PREFERRED EMBODIMENTS OF THE INVENTION

In the following description of the figures same elements will be designated by same reference numerals.

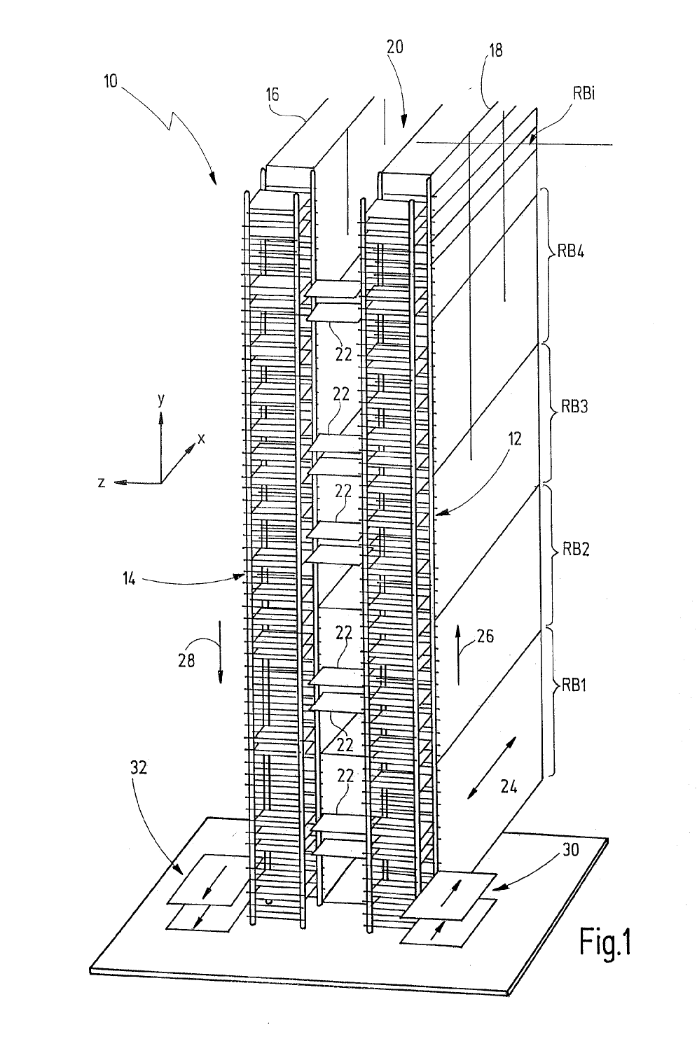

FIG. 1 shows a schematic perspective view of a front end of a first embodiment of the present invention. FIG. 1 shows a rack system 10 as employed in an order-picking warehouse.

The rack system 10 is preferably positioned on a base floor 11 of a hall, and particularly reaches up to the ceiling of the hall (not shown). At a front end of the rack a first vertical elevator 12 and a second vertical elevator 14 are arranged. The rack itself can be formed by single racks 16, 18 and/or double racks (not shown). Each of the single racks 16, 18 comprises a plurality of rack regions RRi (i=1, . . . , n) arranged on top of each other. Five rack regions RR1-RR5 are exemplarily depicted in FIG. 1. Each rack region RRi comprises a plurality of rack planes RPi arranged on top of each other. Each rack plane RP in turn comprises a plurality of rack-storage locations arranged side-by-side. In the present example, each rack-storage location functions as a storage location for a load support, particularly for a tray loaded with articles (e.g. one pallet layer of articles). It is clear that also other load supports, such as containers or the like, could be used. The trays, which are used here, particularly comprise an area which is as big as a base area of a (Europool) pallet. Usage of trays being loaded with one pallet layer has particular advantages, and is described in more detail in the German application DE 10 2006 025 618, which is herewith incorporated by reference in its entirety and has been filed on behalf of the Applicant of the present application on 24 May, 2006.

The racks 16, 18 comprise a plurality of rack posts (not shown) being substantially arranged vertically. Hold elements extending substantially horizontally are mounted on the rack posts, the hold elements normally carrying the trays freely. The hold elements are typically formed by, for example, L-shaped profiles or rails. These profiles typically extend transversely (Z-direction) with respect to the longitudinal direction (X-direction) of the rack 16, 18. The profiles allow a huge part of the bottom of the trays to be free, in order to provide a corresponding contact area for a load-suspension device of a storage machine (not shown). The storage machine can thus reach beneath and exchange any tray stored in the rack.

Returning to FIG. 1, an aisle 20 is formed between the racks 16, 18. The aisle 20 is divided into 5 aisles, arranged on top of each other, in the vertical direction corresponding to the rack regions RR1-RR5, and serves for respectively receiving at least one storage machine SM. The storage machines SM are depicted in FIG. 1 for the purpose of a better overview. The storage machines move along the aisles 20 substantially in the longitudinal direction (X-direction) of the rack system 10 as depicted by an arrow 24. In order to reach all rack planes RPi of a rack region, the storage machine can also be displaced in a vertical direction (Y-direction). An arrow 25 indicates an exchange direction (Z-direction, transverse). Trays are exchanged in the direction of the arrow 25 between the rack and the storage machine, or between the storage machine and a vertical lift.

The storage machines are provided with one or more load-suspension devices, which are exemplarily indicated by 22 in FIG. 1. Each storage machine in the example of FIG. 1 is provided with two load-suspension devices 22. The number and relative arrangement of the load-suspension devices 22 can be selected arbitrarily.

At a front end of the exemplary racks 16, 18, for example, two vertical elevators 12 and 14 are arranged in FIG. 1. The vertical elevator 12 conveys vertically upward, as indicated by an arrow 26. The vertical elevator 14 conveys vertically downward, as indicated by an arrow 28. The vertical elevators 12 and 14 function as paternoster elevators, i.e. they rotate endlessly. The exact function will be explained hereinafter in more detail. It is clear that a conveyance direction can be selected freely. Further, also one vertical elevator 12 or 14 can be provided alone. The conveyance direction can change.

In a foot region of the elevators 12, 14, each of them is optionally connected to a conveyor 30, 32 or the like. The connection preferably happens directly, i.e. without additional buffer elements between the vertical elevators 12, 14 and the conveyors 30, 32. Each arbitrary conveyor type can be used for the conveyors 30, 32, such as a belt conveyor, a roller conveyor or the like. Here, the conveyors 30, 32 are respectively formed double high. This means, respectively two conveyor lines are arranged on top of each other. The number of conveyor lines arranged on top of each other (or side-by-side) can be selected arbitrarily, depending on the need. The conveyor 30 is used for transporting load supports. Supply of fully loaded load supports happens, for example, via the conveyor 30. The conveyor 32, for example, is dedicated to transporting away load supports, preferably to an order-picking station or a work station (i.e. packing station, etc.). Also here, the conveyance directions can be exchanged, or altered. Also, only one conveyor, or a conveyor track, can be provided.

For storing a loaded tray into one of the racks 16, 18, the tray (not shown) is transported to the vertical elevator 12, for example, via the conveyor 30. Then, the tray is pushed from the conveyor 30, for example, by means of a pusher or any other displacement device into a free (unoccupied) elevator-storage location. The elevator 12 is preferably operated in a clocked manner, so that the tray can be pushed into the elevator 12 at a given point in time. Subsequently, the tray is transported to the level of a desired rack region, such as the level of the rack region RR3, in the direction of the arrow 26. As soon as the tray is at the level of the rack region RR3, it can be retrieved by a storage machine SM3 assigned to this rack region RR3 which moves in the corresponding rack aisle 20. In this connection, the storage machine SM3 moves to a location in the aisle 20 directly opposite to the elevator 12. The load-suspension device 22 of the storage machine SM3 retrieves the tray, and moves it in the X-direction and/or the Y-direction to a predetermined rack-storage location. Then, the load-suspension device 22 delivers the tray to the predetermined rack-storage location. Thus, a storage process is described. Retrieval happens in an inverted order. First, a predetermined tray is retrieved from a predetermined rack-storage location by means of the storage machine. Then, the tray is delivered, for example, to the elevator 14. As soon as the elevator 14, i.e. the corresponding tray, reaches the level of the conveyor 32, the tray can be delivered to the converter 32. In this context, preferably push or pull devices (not shown) are provided.

In order to increase throughput, the storage machines SM as well as the conveyors 30, 32 in the example of FIG. 1 are respectively arranged double high. Thus, in each cycle, respectively two trays can be exchanged. If a higher or lower throughput is desired, the number the “floors” can be changed arbitrarily. Further, it is also possible to exchange simultaneously two trays located side-by-side (i.e. standing in the X-direction side-by-side). However, in this context, additional vertical elevators would need to be provided subsequently at a front end of the already existing vertical elevators. The same applies with respect to the load-suspension devices 22 of the storage machines.

Another advantage is to been seen in the opposite arrangement of the elevators 12 and 14 with respect to the storage machines. While load supports are delivered to the elevator 14 by the storage machines, new load supports can be received by the elevator 12 at the same time. The time needed for the exchange is cut to a halve, because there is no need to wait for the storage machine delivering its load support, in order to allow the subsequent receipt of new load supports. Here, this can happen at the same time.

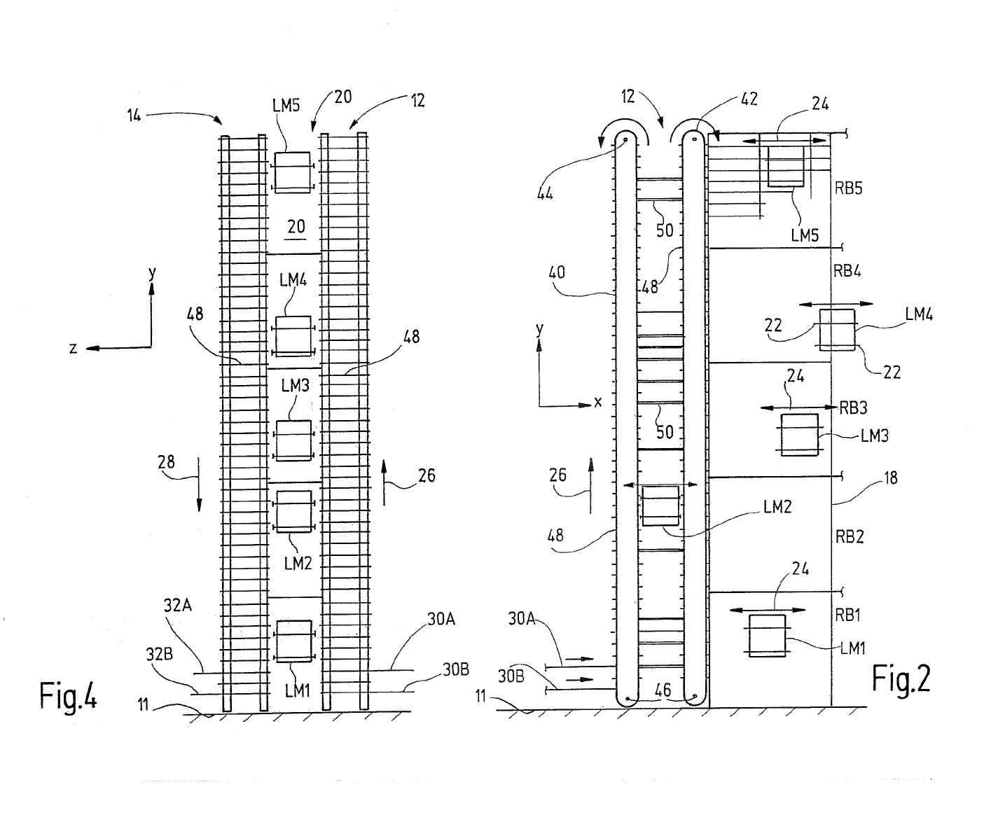

With reference to FIG. 2 a side view of FIG. 1 is depicted, wherein the rack 18 of FIG. 1 is viewed from the right-hand side of FIG. 1. The rack 18 is merely illustrated in part where the vertical elevator 12 is located serving for conveying upwardly.

FIG. 2 exemplarily depicts five storage machines SM1-SM5, wherein one storage machine SM is provided in each rack region RR1-RR5.

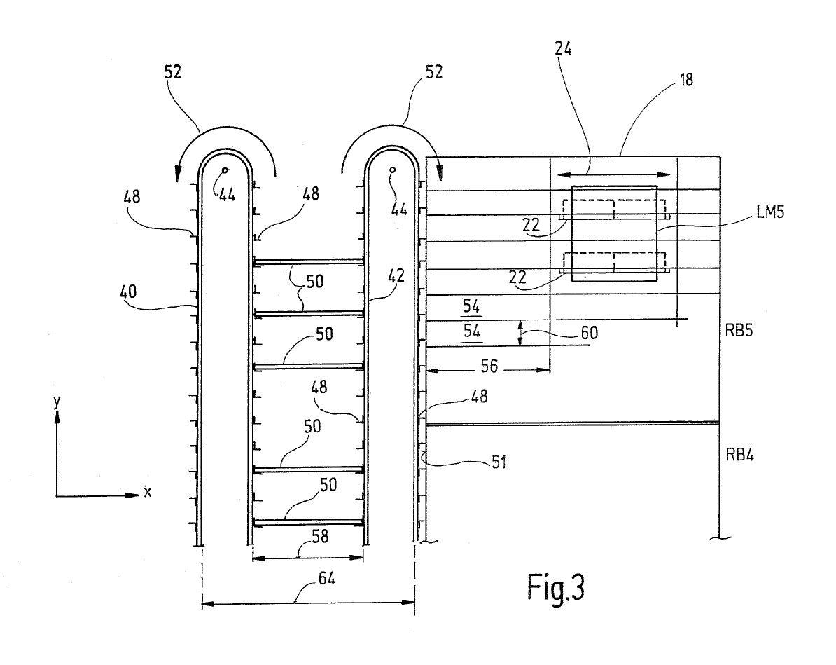

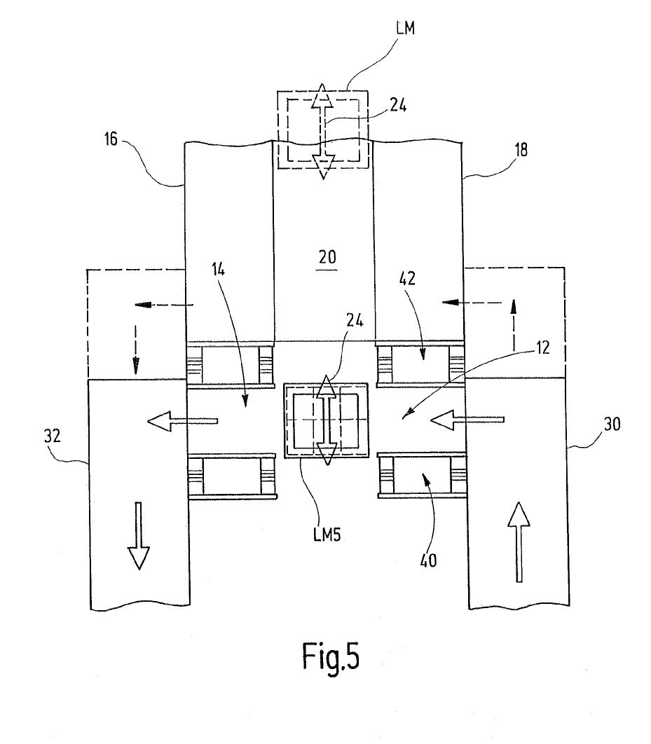

The vertical elevator 12 connects to a front end to the rack 18 (cf. FIG. 3) at 51. The elevator 12 comprises a first traction unit 40 as well as a second traction unit 42, which respectively are returned at an upper return point 44 and a lower return point 46. The traction units 42 and 44 can be formed, for example, in terms of chains, which preferably are provided in pairs (cf. FIG. 4).

The traction units 40, 42 rotate endlessly. Preferably, this happens in a synchronous manner, in order to transport load supports, which are stored between them, upward (cf. arrow 26) in a regular manner.

For this purpose, the traction units 40, 42 comprise a plurality of support elements 48. The support elements 48 can be implemented in terms of profiles having, for example, L-shaped cross sections. The support elements 48 are mounted to outer strands of the traction units 42, and extend substantially in a horizontal direction. The support elements 48 of the traction units 40, 42 are preferably distanced equally with respect to each other. Preferably the distance between the support elements 48 is substantially as big as the distance between the hold elements of the rack-storage locations.

The distance between the inner extending strands of the traction units 40, 42 (X-direction) is selected such that the distance substantially corresponds to the width of a rack-storage location. In this manner one achieves that an elevator-storage location is almost defined equivalently in comparison to a rack-storage location. This simplifies the handling of load supports significantly. Further, the control of the storage machines SM is, thereby, substantially facilitated, since the load-suspension device of the storage machines SM does not need to be adapted to the elevator-storage locations.

A number of trays 50 are exemplarily depicted in FIG. 2, which have been transported via the conveyor 30 to the elevator 12, and subsequently by the elevator 12 in the vertical direction 26 upwardly. The trays 50 are empty for the purpose of simplification. It is clear that in case of filling the rack 18, these trays 50 are loaded. If one of the trays 50 reaches a predetermined height, then it is retrieved by the corresponding storage machine SM, which in turn is moved directly to the elevator 12 (cf. arrow 14) for this purpose.

As can be seen best in FIG. 2, the vertical elevator 12 is small in the X-direction as well as in the Y-direction. The additional space for a prior art gondola lifter, particularly in the X-direction, can be almost completely omitted here. Only the drive (not shown) contributes to an additional height.

The elevator 12 is provided with a very large number of elevator-storage locations. The elevator 12 actually represents a type of conveyor extending in the vertical direction. The disadvantage known in the prior art, i.e. only a small number of load supports can be used for each vertical travel, is completely omitted here.

The elevators 12, 14 are preferably operated in a clocked manner, i.e. there are phases during which the support elements 48, or the elevator-storage locations, are moving, and phases within which the support elements 48 are at rest for an exchange. The storage machine can travel to a plurality of elevator-storage locations during the rest phase. Contrary to the prior art, wherein merely one handing-over height for each rack region was present, load supports can here be exchanged between the storage machine and the elevator in many different heights. Even if the preferred handing-over height is occupied, there can be an exchange at another height, since the storage machine can normally travel vertically. This increases the flexibility significantly.

In FIG. 3 another part of FIG. 2 is depicted enlarged and isolated. Return devices of the traction units 40, 42 are indicated by arrows 52.

Rack-storage locations are designated by 54. Elevator-storage locations are designated by 55. The width of a rack-storage location is designated by 56. The width of an elevator-storage location, or the distance between the inside-located strands of the traction units 40, 42, is designated by 58. The widths 56, 58 are particularly equal. The storage locations 54, 55 preferably are equally big.

A distance 60 of the rack-storage locations in a vertical direction is preferably as big as a division 62 of the support elements 48 on the traction units 40, 42.

The entire width 64 (in the X-direction) of the elevator 12 is only insignificantly bigger than the width 56 of one rack-storage location 54.

FIG. 4 shows a front view of the system 10 of FIG. 1.

The upward elevator 12 is depicted on the right-hand side. The downward elevator 14 is depicted at the left-hand side. It is clear that the travel directions of the elevators 12, 14 can be exchanged. Further, the elevators 12, 14 can also be operated upwardly and downwardly.

The traction units 40, 42 particularly comprise two chains arranged side-by-side in a Z-direction. The chains are fixedly connected to each other in a horizontal direction by means of the support elements 48. It is clear that instead of the profiles 48, which allow a line-shaped support of the trays 50, also single support elements 48 could be provided, not connecting the chains to each other. In this case, the support would be point-by-point.

FIG. 5 shows a top view of the system 10 of FIG. 1. A dotted line indicates that the conveyors 30, 32 could also extend beyond locations, where the elevators 12, 14 are directly opposite to each other. In this manner, trays could be directly delivered to the rack region RR1 (cf. FIG. 2). The supply of the rack region RR1, thus, would be self-sufficient with respect to the elevators 12, 14. The elevators 12, 14 would only be needed for the rack regions RR2-RR5 lying thereabove. This additionally makes the burden easier for the elevators 12, 14.

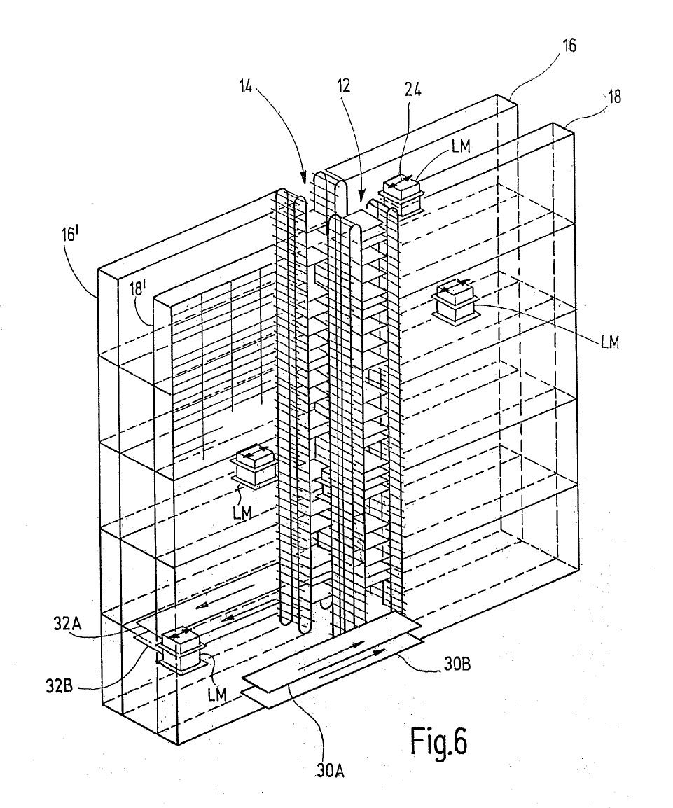

Another embodiment of a system 70 in accordance with the present invention is shown in FIG. 6.

In FIG. 6, the elevators 12, 14 are integrated in racks 16, 18 and 16′, 18′. Deviant from FIG. 1, the elevators 12, 14 are not (only) arranged at a front end but can additionally or alternatively be arranged centrally in the racks. Particularly, in the order-picking warehouse as mentioned at the outset, as it has been invented by the present applicant, this type of arrangement has resulted in saving of space. The vertical elevators, which are typically arranged laterally to the racks, are integrated in the rack. The storage machines can directly deliver trays to the elevators, i.e. without handing-over locations.

It is clear that a number of elevators can be integrated into the rack for each rack row.

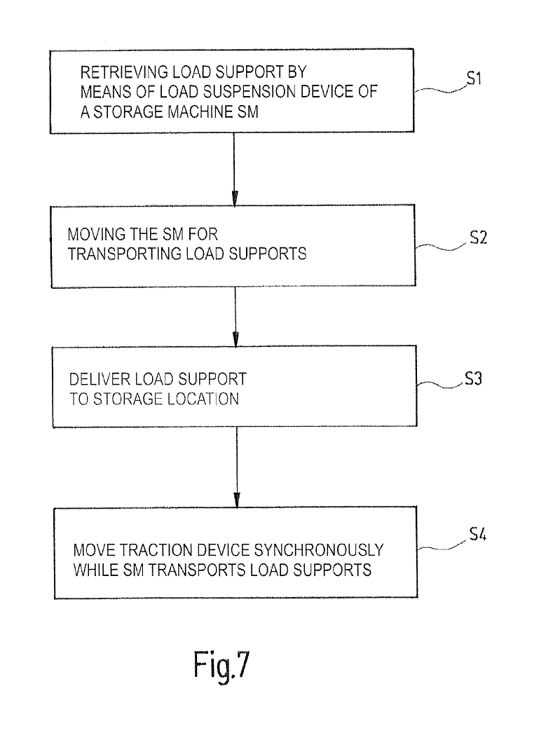

A flow diagram of a method in accordance with the present invention is illustrated in FIG. 7.

In step S1, load supports are retrieved from a predetermined rack-storage location, or an elevator-storage location, transversely with respect to a longitudinal direction of the rack by means of a load suspension device of a storage machine.

In a step S2, the storage machine is moved in the longitudinal direction and/or in a vertical direction, in order to transport one or more load supports between the storage locations.

In a step S3, retrieved load supports are delivered in a transverse direction to a predetermined elevator-storage location, or a rack-storage location.

In a step S4, the first and second traction units are moved synchronously, preferably in a clocked manner, while the storage machine transports one or more load supports between the storage locations.

Therefore, we claim:

1. An order-picking system comprising a storage rack, wherein the rack is divided into a number of rack planes arranged on top of each other, each having rack-storage locations arranged side-by-side, and wherein the rack is coupled to a vertical elevator, wherein the vertical elevator serves for transporting load supports from a rack-plane level of the storage rack to a handing-over level, and vice versa, wherein the elevator is provided with a first vertical traction unit endlessly rotating, and a second vertical traction unit endlessly rotating, wherein the first and second traction units can be driven substantially synchronous and are distanced to each other such that a plurality of first support elements, which are mounted on the first traction unit, and a plurality of second support elements, which are mounted on the second traction unit, define a corresponding plurality of elevator-storage locations, on which load supports can be conveyed in a vertical direction between the levels.

2. The order-picking system of claim 1, wherein the rack-storage locations comprise hold elements mounted laterally to posts of the rack.

3. The order-picking system of claim 1, wherein the elevator couples to a front end of a storage rack.

4. The order-picking system of claim 1, wherein the elevator is integrated in the storage rack.

5. The order-picking system of claim 1, wherein the first and second traction units are driven synchronously by means of one drive unit.

6. The order-picking system of preceding claim 1, wherein the first and second traction units are respectively formed of two endlessly rotating closed strands.

7. The order-picking system of claim 6, wherein the respectively two strands are connected to each other by means of the support elements in the horizontal direction.

8. The order-picking system of claim 1, wherein the support elements are formed identically with respect to the hold elements.

9. The order-picking system of claim 8, wherein the support elements are profiled rails.

10. The order-picking system of claim 1, wherein the load supports are transported back and forth between rack-storage locations and elevator-storage locations by means of storage machines.

11. The order-picking system of claim 10, wherein the storage machines are movable in vertical and horizontal directions.

12. The order-picking system of claim 1, wherein a distance of the elevator-storage locations in a vertical direction, with respect to each other, is selected equal to a distance of the rack-storage locations.

13. The order-picking system of claim 1, wherein the elevator-storage locations are formed single deep or multiple deep.

14. The order-picking system of claim 13, wherein the elevator-storage locations are formed in correspondence with a storage depth of the storage racks.

15. The order-picking system of claim 1, wherein the support elements are formed and arranged so that they support a load support laterally at a bottom thereof such that a load suspension device of a storage machine can reach freely beneath the bottom, in order to lift the load support into an elevator-storage location, or out from of the elevator-storage location.

16. The order-picking system of claim 1, wherein the traction units further comprise return devices, the axes of which are orientated transversely with respect to a longitudinal direction of the rack.

17. The order-picking system of claim 1, further comprising another storage rack having another elevator, wherein the storage racks define an aisle therebetween, and wherein the vertical elevators are arranged oppositely so that the storage machine can deliver load supports to one of the elevators, while the storage machine delivers load supports to the other vertical elevator.

18. The order-picking system of claim 1, wherein a conveyor connects to the vertical elevator at the handing-over level.

19. A method for storing and retrieving load supports in an order-picking system comprising a storage rack, wherein the rack is divided into a number of rack planes arranged on top of each other, each having rack-storage locations arranged side-by-side, and wherein the rack is coupled to a vertical elevator, wherein the vertical elevator serves for transporting load supports from a rack-plane level of the storage rack to a handing-over level, and vice versa, wherein the elevator is provided with a first vertical traction unit endlessly rotating, and a second vertical traction unit endlessly rotating, wherein the first and second traction units can be driven substantially synchronous and are distanced to each other such that a plurality of first support elements, which are mounted on the first traction unit, and a plurality of second support elements, which are mounted on the second traction unit, define a corresponding plurality of elevator-storage locations, on which load supports can be conveyed in a vertical direction between the levels, the method comprising the following steps:
retrieving a load support from a predetermined rack-storage location, or an elevator-storage location, transversely with respect to a longitudinal direction of the rack by means of a load suspension device of a storage machine;
moving the storage machine in at least one of the longitudinal direction and vertical direction in order to transport one or more load supports between the storage locations;
delivering the retrieved load support in a transverse direction to a predetermined elevator-storage location, or a rack-storage location; and
synchronously moving the first and second traction units while the storage machine transports one or more load supports between the storage locations.

20. The method of claim 19, wherein the synchronously moving happens in a clocked manner.

21. The method of claim 19, comprising the further steps of:
moving the storage machine to a handing-over point opposite to the elevator; and subsequently exchanging load supports between the elevator and the storage machine in the transverse direction.

22. The method of claim 19, comprising the further steps of:
moving a load support stored in the elevator in a vertical direction to the handing-over level; and
delivering the load support in the transverse direction to a connected conveyor.
